(19) United States
(12) Patent Application Publication
(10) Pub. No.: US 2009/0279945 A1
(43) Pub. Date: Nov. 12, 2009

(54) SNAP CLAMP AND POSSIBLE MOUNTING TOOL

(76) Inventors: Brian Rise, Skaelskoer (DK); Tom Jonsson, Skaelskoer (DK)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/306,464

(22) PCT Filed: Jun. 25, 2007
(86) PCT No.: PCT/DK07/00303

§ 371 Date: Dec. 23, 2008

(30) Foreign Application Priority Data
Jun. 26, 2006 (DK) PA 2006 000858

(51) Int. Cl. F16B 7/04

(52) U.S. Cl. 403/217

(57) ABSTRACT

A snap clamp for mounting of substantially constant outer cross section article-types, to a support structure offering at least two stacked layers of crossing rod-shaped lengthy elements for the mounting—an example being clamp mounting of flextube for a floor heating system, to a reinforcement grid laying on a room's raw floor. The clamp has an overall box-shape with substantially square section normal to it's length direction. Four flexing gripping fingers (104) to receive and hold the article in one of two mutually perpendicular lateral directions (X, Y) are comprised at one end (103), and the other end (106) comprises two mutually perpendicularly crossing U-shaped snap grooves (107, 108) of different depth, to attack both wires at a mounting cross-point. Differing side profilations (151, 152) are inventively provided to secure correct angle rotation of clamp (101) over cross-point at mounting time. A supplementary mounting tool also being inventive.

### FIELD OF APPLICATION

The present invention relates to an improved snap clamp comprising the basic characteristics as indicated in the preamble of claim 1, for mounting of substantially constant outer cross section article-types to a support structure offering at least two stacked layers of crossing rod-shaped lengthy elements for the mounting, an example of mounting of such type being mounting of flextube for a floor heating system, to a reinforcement grid laying on a room's raw floor, by means of intermediary snap clamps. This invention also relates to a mounting tool for an actual inventive snap clamp, if such mounting tool is provided.

### BACKGROUND

Snap clamp mounting of articles is a highly productive method utilizing flexible snapping features of fixing clamps which often have specialized design features to guarantee safe primary function—holding together items—and to also fulfill other requirements from the actual mounting situation.

E.g. in the situation of mounting flextube for a building's floor heating system, avantage is often taken from the module dimensions of conventional reinforcements grids of crossing layers of (tentor-) steel wires/bars fused at crosspoints, or of specially adapted wire-nets of similar advantageous design. Whether contributing or not to reinforcement of concrete or the like, which possibly later—after the mounting—is poured to create a floor face, such type of support structure is often used in the planning of the geometrical path of the floor heating flextube. Such path can be fairly complicated according the special needs to concentrate heating in some areas and to avoid/reduce heating elsewhere. The flextube is of relative stiff nature and must almost always be mounted with many bends in it's path along the support structure. Mounting over support structure crosspoints is often imperative, to take up force reactions from the flextube, in any direction along the supporting plane. Moreover a flextube position a little distant from the support structure is often required to avoid wear phenomena from e.g. rubbing; corrosion; local penetration.

### PRIOR ART AND DISADVANTAGES

One snap clamp type for mounting at support structure's crosspoint(s) is known as a “crosspoint-connecting-type” (e.g DE-7921935-U) having a very complicated insertion direction from “behind”—in our example a lying suppport structure must be lifted from the floor, the clamp be manipulated in position under the reinforcement grid, requiring substantial lifting distance from the underlying layer to pass the clamp under wires to a crosspoint, and then afterwards apply force from below to snap in this clamp type around the crosspoint's wires. Moreover only one direction of the article held is comprised.

From DE-8024216-U is known a clamp type being able to relatively free in top wire direction “ride” on a crosspoint's top wire, the crossing lower wire being attacked by snap hooks pushed or twisted in place from the side—after the reinforcement grid has been lifted to create clearance for the hooks below the lower wire.

Both types don't permit the support structure's lower wires to be stably lying on a surface during and after the mounting because of material disposal under the lower wire, also meaning that a relatively slight grid easily will have its thin wires bent up out of plane, when one or more persons later walk around on the grid and step near mounted clamps during the fixation of the flextube to the clamps.

A much more productive type of snap clamp is appearantly known to originate only from DK PA 2004 01386. This “DK” snap clamp has several elegant features to speed up and secure the mounting procedure on a lying support structure, by not requiring lifting of the support structure for snap clamp placement on to a cross-point or on to one wire alone, and by not requiring any free distance below the lower layer's wires/bars. The paramount feature of this DK snap clamp being it's ability to be mounted on to a crosspoint from the direction perpendicularly towards the plane of the top layer of the support structure's rod shaped elements. The functionality of this unique snap clamp will already now be explained herebelow with reference to the present application's FIGS. 1 and 2, as our inventive efforts set out from this DK snap clamp type.

FIG. 1 shows isometrically an embodiment (1) of the highly preferred DK snap clamp lying with one side face (2) on an imaginary surface. This PRIOR ART snap clamp's design is, as easily seen, of overall box-shape with a substantially square section normal to it's length direction (Z). At one end's (3) corners the snap clamp has four flexing longitudinal gripping fingers (4) to receive and hold an article of substantially constant outer cross section along at least a relevant part of it's length, such article preferably being a flextube for a floor heating system (or else e.g. can be a tube for a cooling medium or water, an electrical cable, a profile for mounting purpose or other), in one of two mutually perpendicular lateral directions (X, Y). The article's relevant outer cross section is to a degree sufficiently satisfying the requirements to secure clamping and adequate rotational fixation, reflected by the shape of finger's gripping surfaces as (5). Shown is gripping surfaces partly describing a circular circumference being suited for holding of an article with circular or e.g. hexagonal cross section. Preferably the gripping surfaces are shaped/dimensioned for a same cross section being mountable in either the X- or the Y-direction by being pressed in the Z-direction towards the snap clamp's other end face (6).

This other end face (6) is more clearly visible on FIG. 2 showing the same embodiment (1) of the DK snap clamp lying with the same side face (2) on the imaginary surface and being rotated 180° around an axis in the Y-direction. From this end face (6) two mutually perpendicularly crossing substantially Ushaped snap grooves (7, 8) are extending between opposed side faces, one snap groove (7) being deeper from the end's plane (6) to fit; at mounting time receive and (later) hold, a (not shown) rod-shaped element from the support structure's outer layer. Notice that the snap clamp (1) can be rotated to two possible positions around an axis in the Z-direction to such receiving position. The other snap groove (8) has a substantially less depth from said end's plane (6) to—at a cross-point—fit; a little later at mounting time receive; and simultaneously with the deeper groove (7) hold, a (not shown) rod-shaped element from the support structure's adjacent/lower layer. Of course, the dimensions (opening width and depth) of the U-grooves are adapted to the relevant support structure whose rod-shaped elements preferably have same characteristic outer diameter. The initial snap effect around rod-shaped elements can be improved by means of a slight U-groove undercut reducing the gap nearer the end face (6), as indicated at (9) and (10). The four legs (12) around the U-grooves from the (6)-end face are hollowed by through holes (13) to reduce material comsumption. An enlargement of the free volume at the crossing of the U-grooves is provided to take up surplus (splattered) material from the fusing of the rod-shaped elements at a cross-point. Here, such extra free volume has the form of a circular hole (14), from the end face (6) intruding to approximately the depth of the deeper U-groove (7).

Again turn to FIG. 1: At the side faces, and extending in a Z-direction from the receiving openings described by neighbouring gripping fingers (4), relatively small slits (15, 16) are comprised. The slits (15) pointing to the top of the deeper U-groove (7) end a distance therefrom, thus defining a flexible hinge area of adjusted material thickness between the slits (15) and the deeper U-groove (7), the flexing axis being in an X-direction. The DK snap clamp embodiment (1) is shown with supplementary free space between the fingers (4) in the center area, such shaping being the result of efforts to further reduce clamp material consumption. To note here is, that the depth profile of the slits (15) also should be intruded along an X-direction through any clamp material blocking between the slits (15) at the opposed side faces, to also inside the clamp volume yield reduced material thickness for the flexible hinge. This effect is actually shown for the slits (16) also in a Zdirection pointing to the top of the less deep U-groove (8) also leaving an adapted thickness of clamp material between, defining a flex hinge area flexible around an axis in a Y-direction. Here, the depth profile of the slits (16) is intruded along a Y-direction through the clamp material covering the deeper U-groove (7) yielding an internal slit (17), thus securing reduced material thickness all way between the slits (16) at the opposed side faces. Note, that the axes of these two flex hinges just described, seen in a Z-direction are mutually spaced by a distance comparable to the outer diameter of the top wire. Therefore, the flexibility of these “hinges” allow partly the respective juxtaposed U-groove to widen or narrow, partly the receiving profile for an article parallel thereto, also to widen or narrow.

Having these many ingenious functionalities in mind, the fast and effective mounting of a DK snap clamp is easily understood:

Crawling or walking bowed/crouched around on a support structure (e.g a reinforcement grid laid out on a room's raw supporting floor) you spot the places of the grid, preferably the crosspoints, planned for reception of a clamp for holding the article (e.g. a flextube for the room's floor heating system) to the grid structure. From e.g. a bag or box you grab one DK snap clamp like (1) with relevant dimensions of U-grooves (7, 8); article receiving openings (5); etc, brought for the job. The corresponding U-groove is then positioned over the support structure's actually upmost wire/bar being a (7)- or (8)-type Ugroove, respectively, over a top layer wire/bar or adjacent layer wire/bar, if the mounting place is not over a cross-point comprising both top and adjacent wires. At a cross-point the deeper U-groove (7) is placed over and along the top wire/bar, the adjacent layer's more distant wire/bar being aligned under the less deep U-groove (8). Now, pressing the DK snap clamp (1) downwards sliding over the wire(s), will widen the respective Ugroove to receive it's wire by flexing of the juxtaposed flex hinge. If at a cross-point, widening will happen in a sequence, the deeper U-groove (7) first being opened by the top wire. At the end of this pressing movement, wire(s) “bottom(s)” in the respective groove's U-bow(s) with some snap gripping effect around wire(s), due to flexing back forces from the respective juxtaposed flex hinge. Should a local wire/bar material protrusion/deformation hinder the “bottoming” forced only by hand, stepping on the DK snap clamp (1) with a foot, or a moderate blow from a tool, e.g. block of wood, on the finger end face (3) will complete the “bottoming” movement.

Article mounting of e.g. a flextube for the room's floor heating system now follows, and is executed simply by positioning of the flextube over the DK snap clamp (1), in the planned one of the possible two mounting directions substantially being parallel to the X- and the Y-directions, respectively. From above (in Z-direction) the flextube is then pressed (e.g. by hand or footstep) to seat against the relevant receiving surfaces (5) of the four fingers (4) after having widened the receiving opening to pass, by flexing of finger material and of the juxtaposed flexing hinge. Always at crosspoints, and else in situations with the flextube/article parallel to the clamped wire/bar direction, the ingenious thinking that created the DK snap clamp, reveals an other important feature: After snapping back to a slightly widened position around the article to hold same with adequate elastic forces, the thus spread finger-pairs via the juxtaposed flexing hinge, like a pair of inverted pliers, transmit additional clamping force to the parallel wire by the effect of the force-lever-principle, thus substantially improving the clamping stability. Here is to note, that the depths of the U-grooves (7, 8), i.e. the length of the legs (12), easily are designed so no clamp material protrude behind/below the support structure's adjacent layer's plane, permitting e.g. a reinforcement grid's lower layer of wires/bars to stably rest on the same surface all time, even during and after mounting of the DK snap clamp—and of the article to the clamp.

Therefore we worked a lot with the DK snap clamp (1), utilizing it's many favourable technical features explained above to achieve great savings in mounting time and to now receive almost no complaints from the concrete pouring workers regarding flextubes being loosened or misplaced due to malfunction of the snap clamp during the concrete pouring and leveling out operations.

However, our intense handling of DK snap clamps, has revealed a couple of disadvantages:

The primary disadvantage being the overall outer symmetry around the Z-axis, rendering it difficult by hand/finger gripping to easily detect the orientation of the U-grooves by their differing depths—especially at cross-points—being specific either to a wire from the top layer or to a wire form the adjacent layer. Often the less deep U-groove (8) is pressed over a top wire, leaving the snap clamp waggly on the top wire, thus requiring removal and repositioning on the top and adjacent wires after a quarter-turn around a Z-direction of the clamp. Alternatively more time and handling effort for each clamp mounting must be additionally spent (=wasted) to intensely either look at the snap clamp, or finger around the (6)-end face, to detect the respective U-groove orientations, to correctly position the DK snap clamp like (1).

The other disadvantage results from the relatively small physical area of the finger-end surfaces (3) to contact (normally by hand) to press down the clamp around a wire/bar. The hand's grip in this situation is neither well defined, nor having a suitable direction for applying the pressing force under good ergonomic conditions. After prolonged work with snap clamp mounting, severely aching and even wounded hands were reported due to this bad ergonomy. Use of working gloves proved unsatisfying due to the difficulties to then from a bag or box grab the randomly oriented snap clamps of relatively small size compared to the gloved finger's dimensions and maneuverability.

During our work with the DK snap clamp type (1) we also came to think of a variant with reduced length to further save snap clamp material and to possibly reduce the requirement to overall layer thickness of poured concrete: We reduced the distance between the deeper U-groove like (7) and the nearest part of the recieving opening between the finger pairs for the juxtaposed article position, thus saving almost a full square-ring-volume of material, the Z-direction depth of the slits like (15 and 16) simultaneously being reduced (even to nil for the 15-type). Moreover we made variants comprising holes, some being through holes, intruding from non-critical places on the side faces to further reduce the amount of material consumed by each snap clamp.

### PURPOSE OF THE INVENTION

For the purpose of remedy of the first of above-mentioned disadvantages we created an improved snap clamp of substantially above DK type, possibly also comprising our “own” variants mentioned right above, this spectrum of snap clamp variants generally being as specified in the preamble of claim 1. To the supplementary remedy of the other above disadvantages we on the same idea of the improved snap clamp created an adapted supplementary mounting tool type to possibly use for mounting of actual inventive snap clamp(s), such adapted mounting tool-type especially being beneficial to heavy users like e.g. professional installers.

### DISCLOSURE OF THE INVENTION

The important improvement consists of the provision of means to a claim-1-preamble type snap clamp, for easier detection by hand/fingers of the U-groove orientations, such inventive means being a section profile of at least one of the four outside corners, having a form which geometrically is clearly different from the form(s) of other corners. In practice such profilations can be combinations of corner forms being e.g. sharp; rounded (as known from the DK-type); chamfered; notched; non-symmetric about corner's diagonal; concave. If provided—the possible supplementary mounting tool being inventively is adapted to such actual characterized snap clamp by means of a plate, channel, receptor, or the like, comprising a (through-) hole, cut-out, or “mask” with corner profilations of more than one form having mutual relative positions coordinated with the different corner profilations of the actual characterized snap clamp, to hinder longitudinal insertion/reception in the mounting tool, of the actual characterized snap clamp in an undesired state of position, by physically blocking the entrance/passage of one or more corners of the actual characterized snap clamp.

The beneficial features resulted from the invention substantially help the installer to “in the blind” with the hand/fingers determine the positions of the respective U-grooves during the grabbing from a bag or box. Therefore the inventive snap clamp directly, without further time-wasting manipulation/visual observation, can be positioned correctly on to the planned place of mounting preferably being a cross-point, as from the spotting of the place of mounting the installer also in advance knows the orientation and layer position(s) of the wire(s) locally present at the actual place for mounting.

The additional use of a mounting tool generally provides better ergonomics by e.g. improving the gripping characteristics and by defining a more suitable direction of force application. The inventive mounting tool possibly provided to facilitate the mounting of an inventive snap clamp in an actually selected embodiment (regarding e.g. corner's configuration, size of support structure's rod-shaped elements, and of article's characteristic outside diameter) shows beneficial by securing correct insertion of the actual inventive snap clamp in the tool, before mounting to the support structure, the inventive means herefor being generally a physical “masking” structure with coordinated corner configurations. The mask's corner configuration only allows passage/insertion of the actual inventive clamp in planned orientations, in practice meaning that the respective orientations of the clamp's two U-grooves are unambiguously defined in relation to known direction of the tool, thus also securing correct mounting of inventive snap clamp with the inventive thereto adapted tool.

Other embodiments of both the inventive snap clamp, and of the inventive mounting tool, are mentioned hereinafter and are specified in the other appended claims depending on claim 1.

Preferably the inventive snap clamp has two sharp cornes diagonally opposed, the two other cornes relatively being clearly non-sharp. The relative positions of the U-grooves permit maintaining of the mounting functionality to the support structure after a 180° rotation around the length (Z-) direction. Therefore the diagonal (=180°) repetition of e.g. one sharp corner reduces the handling effort to correctly orient the inventive snap clamp in one of its two acceptable positions for mounting to wire(s)/bar(s), especially ay cross-points. Preferably a provided inventive mounting tool also comprises a mask with opposed sharp corners to define one of the two allowable 180° rotated positions for e.g. the just mentioned inventive snap clamp, before it's accept for insertion in the tool. The mask must also allow any of the two other (non-sharp) clamp corners to pass any of the two non-sharp corners which however are blocking for the clamp's sharp corners. A simple tool can e.g. be configured as a one-hand handle centered above a receptor to from below receive the relevant snap clamp in a correctly rotated position, the snap clamp fingers first entering the receptor through the “mask”. Naturally a mounting tool comprises effective indication of the respective U-groove orientations of the actually correctly mounted snap clamp, to guide the installer to orient the tool correctly over relevant wire(s)/bar(s) for the mounting.

Preferably the inventive snap clamp, at the leg corners, has undercut cut-outs matching the form of the fingers of a same snap clamp, thus permitting snapping together in the length direction of more similar said snap clamps on top of another to form a coherent rod-like structure. This feature opens for effective packing and handling of such “sticks” of snapped together inventive clamps.

Moreover it opens up for a preferable inventive tool type containing some magazine for one or more such “sticks” to be received/accepted through an inventive mask e.g. located at the top of some magazine of hollow-tube type. Designed with suitable mechanisms such magazine tool drastically improves the productivity, as the installer now upright can walk around on the support structure, and—via an adapted height of the tool—reach the actual place (cross-point) for snap clamp mounting and correctly apply a snap clamp, without having to bow to the support structure.

As the inventive snap clamps normally from a suitable plastic material are injection moulded one by one (though often many pieces simultaneously), the inventive snap clamp preferably at the leg corners, has cut-outs selectively matching the forms of the fingers of a same snap clamp, thus only permitting snapping together in the length direction of more similar said snap clamps on top of another to form a coherent rod-like structure, substantially all along it's length having same inventive differing outside corner profilations, as a said same snap clamp being extruded along it's length direction. By this means is achieved, that all snap clamps in a “stick” mutually are correctly rotated about the length direction before snapping together to form a stick, as a faulty orientation would result in the snapping together being physically hindered at least one of the faulty finger/leg-corner combinations.

Nothing is more annoying for a motivated installer than having loaded sticks of inventive snap clamps into a inventive tool's magazine through the inventive “mask”, to find out the clamps are leaving the tool—“fingers first” towards the support structure! Therefore the inventive snap clamp preferably has an inventive corner configuration permitting insertion of such snap clamp—especially organized as a “stick”—into an inventive mounting tool through a specially coordinated inventive “mask”, the clamp/stick being accepted in one/more allowable rotational position(s) around it's length direction, if the clamp's/stick's relevant end for mounting the clips correctly “legs first” to the support structure are introduced to the “mask”. But also this inventive “mask” hinders all introduction of a snap clamp/stick attempting entrance with that end first, which causes faulty “finger first”-delivery to the support structure.

### SHORT DESCRIPTION OF THE FIGURES

FIG. 1 shows a typical example of a PRIOR ART snap clamp seen perspectively, the four flexing fingers for article reception seen to the left, the two perpendicularly crossing U-grooves of different depth from other end face seen to the right.

FIG. 2 shows same PRIOR ART snap clamp lying on same side face as in FIG. 1, but now perspectively seen towards the end face with the two U-shaped grooves for e.g a wire crossing point of a reinforcement grid.

FIG. 3 shows schematically the outer profile seen in the length direction of a PRIOR ART snap clamp.

FIG. 4 shows schematically the outer profile seen in the length direction of an embodiment of an inventive snap clamp.

FIG. 5 shows schematically the profile of the opening in a receiving channel/hole/plate/“mask” from an inventive supplementary mounting tool possibly provided to facilitate the mounting of an inventive snap clamp with a corner profilation according to FIG. 4.

FIG. 6A shows schematically as in FIG. 4, an other example of inventive snap clamp outer corner profilation with sharp and rounded corner forms, respectively paired diagonally;

FIG. 6B schematically showing a corresponding mask's similar corner configuration.

FIGS. 7A-7E shows schematically an example of a claim 7 specially coordinated configuration of inventive snap clamp corners and of adapted mounting tool's inventive “mask” corner configuration, the function principle being explained by means of FIGS. 7C-7E; and

FIG. 8 shows, perspectively seen, a present invention snap clamp embodiment.

### FURTHER DETAILED EXPLANATION OF PREFERRED EMBODIMENTS

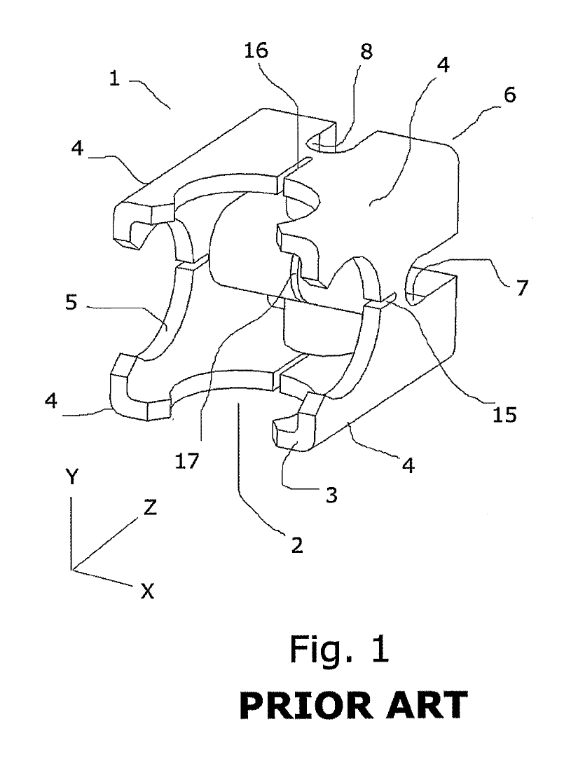

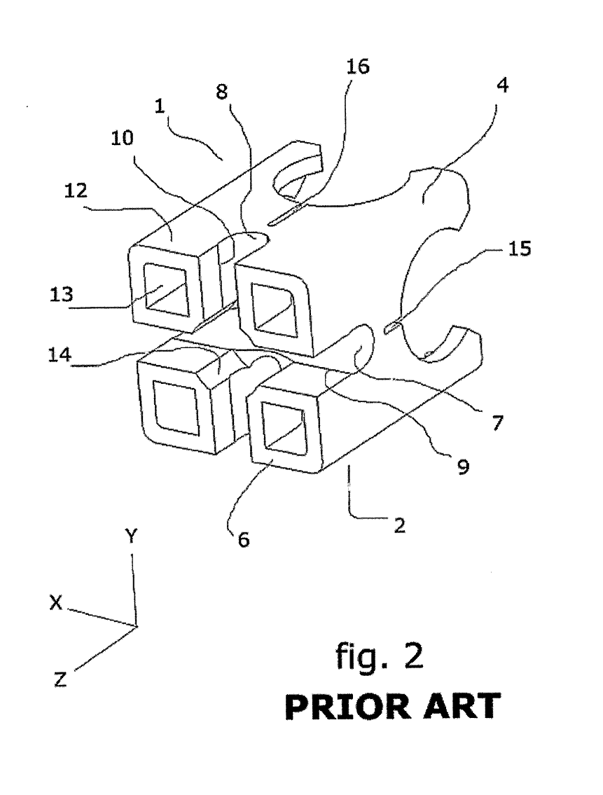

As earlier detailed explained under “Prior art and disadvantages”, FIGS. 1 and 2 show a typical example of a same PRIOR ART snap clamp (1) seen perspectively from either end (3; 6), the snap clamp in both figures being shown lying with same side face (2) on an imaginary supporting face. To repeat here is mainly the four flexing fingers (4) for receiving a (not shown) article, and the two perpendicularly crossing U-grooves (7; 8) of different depth from other end face (6). The deeper Uprofiled groove (7) for receiving a support structure's (not shown) rod-shaped element from the outer layer (if present at the place of mounting), is seen together with the crossing Ugroove (8) of less depth from same end face (6), to receive a support structure's (not shown) rod-shaped element from the adjacent layer (if present at the mounting place). As mentioned, the support structure with outer and adjacent layers can very well be exemplified as a reinforcement grid/net known from the building industry, the article to be mounted to the reinforcement net by means of normally several snap clamps, then being e.g. a relatively thickwalled polymer flextube for a room's floor heating system. Other possible positions in space than the “lying position” should not be forgotten.

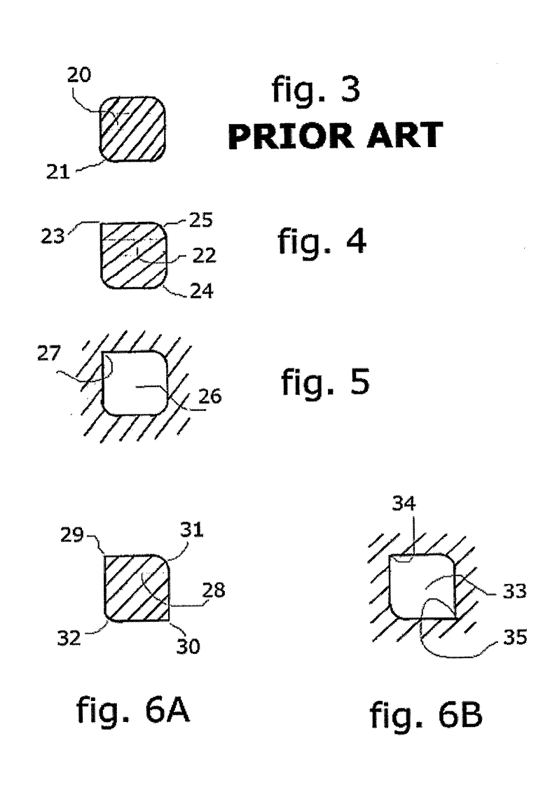

FIG. 3 shows schematically the outer profile seen in the length direction of a PRIOR ART snap clamp like the one illustrated with FIGS. 1 and 2. To note is, that the section (20) is substantially square and having all four corners (21) equally rounded.

FIG. 4 shows schematically the outer profile seen in the length direction of an embodiment of an inventive snap clamp, the substantially square section (22) having one corner shape with sharp edge (23) differing from the other three corner shapes (24) which here have a common rounded shape (25).

FIG. 5 shows schematically the profile (26) of the opening also with one sharp corner (27) in a receiving channel/hole/plate/“mask” from a supplementary mounting tool possibly provided to facilitate the mounting of an inventive snap clamp with a corner profilation (22) according to FIG. 4. It is easily understood, that such corresponding inventive snap clamp only can be received in/through the tool's matching opening profile (26), being in a state rotated around it's length (Z-) direction, which yields coincidence of the sharp corners (23; 27), thus eliminating insertion, if the sharp corner (23) has other position relative to the receiver profile's sharp corner (27).

FIG. 6A shows schematically as in FIG. 4, an other example of inventive snap clamp outer corner profilation (28) with sharp and rounded corner forms, respectively paired diagonally (29 & 30; 31 & 32), thus permitting insertion of one of the clamp's sharp corners (29; 30) in either of a tool mask's similar opening's (33) sharp corners (34; 35) shown schematically in FIG. 6B.

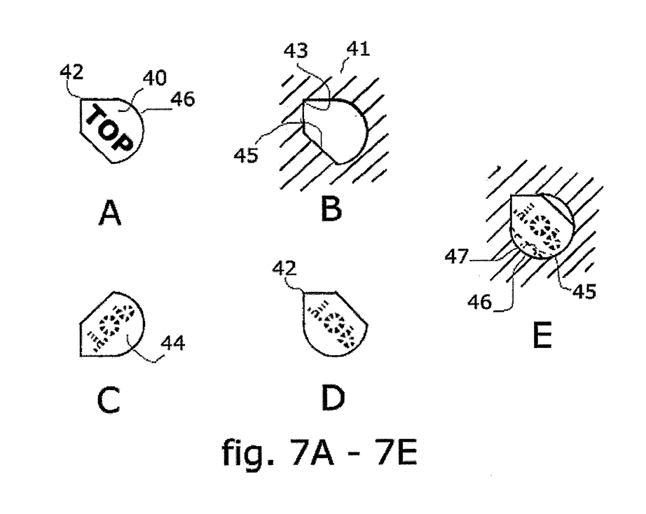

FIG. 7A-E shows schematically an example of a claim 7 specially coordinated configuration of inventive snap clamp corners (40) and of adapted mounting tool's inventive “mask” corner configuration (41), the function principle being explained by means of FIGS. 7C-7E. For better understanding the word “TOP” is written on the top face (40) of the snap clamp, the assumption here being, that the snap clamp—or a “stick” of more of such snap clamps with their profiles (40) covering each other in the length (Z-) direction—must be inserted “TOP up” in the tool to correctly leave the tool “leg first” towards the support structure at mounting time. From the FIG. 7A clamp profile (40) to the FIG. 7B mask profile (41) is easily seen, that the clamp/stick can enter (down into the figure plane) the receiving opening (41), if rotated along the length (Z-) direction as shown in FIG. 7A, the sharp corners (42, 43) covering each other, and other rounded and chamfered corners, clearly respectively being visible are also aligned to allow passage/entrance. If the clamp/stick was presented in a faulty “TOP down” orientation to be passed through the mask (41), the same clamp's/stick's profile would appear e.g. as the profile (44) in FIG. 7C, the word TOP for clarity now being shown in broken lines as seen through the clamp/stick. To achieve entrance through the mask (41) the “TOP down” clamp/stick would be rotated around it's length direction to a position shown in FIG. 7D, the sharp corner (42) seeking a position coincident with the mask's sharp corner (43). By superposition of the “TOP down” clamp/stick on the mask's opening (41) as shown in FIG. 7E, the mask's chamfered corner (45) is easily at (47) seen to physically hinder entrance of the “TOP down” clamp's/stick's rounded corner (46) now being positioned over the mask's chamfered corner (45). Therefore correct insertion of a clamp/stick with e.g. the corner configuration shown (40) is secured by means of a mask with the corner configuration shown at (41).

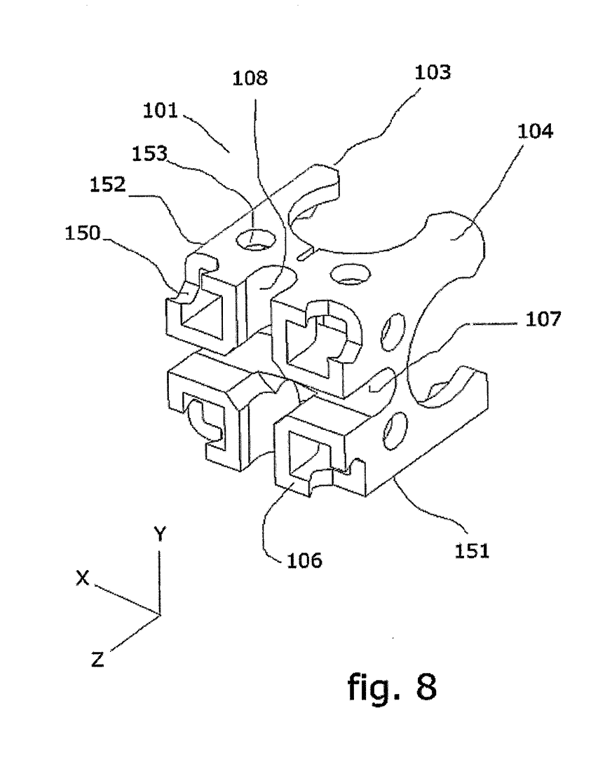

FIG. 8 shows, perspectively seen, a present invention snap clamp embodiment (101), the two perpendicularly crossing U-grooves (107, 108) of different depth from other end face (106) are seen to the left, leg corner cut-outs (150) for an other such snap clamp's fingers (104) also being clearly visible. Hereby is stacking of more such snap clamp on top of each other in the length (Z-) direction made possible. An inventive corner profilation is seen at (151), here being a sharp corner compared to the clamp's other three rounded corners (152). Clamps (101) according to the embodiment shown in FIG. 8 can be combined to a stick having differently rotated positions around the length (Z-) direction of the sharp corners (151) because the finger's (104) ends and the corresponding cut-outs (150) all are similar, respectively. But as explained in relation to the claim 6 embodiment, the leg corners can easily be designed with cut-outs selectively matching the forms of the fingers of a such same snap clamp, thus only permitting snapping together in the length direction of more of these snap clamps on top of another to form a coherent rod-like structure, having same all over inventive differing outside corner profilation as a single such snap clamp being extruded along its length direction. At (153) is shown an example of a material saving hole.

Finally is mentioned, that the understanding of the term “outside corner” of course covers the whole corner area between the boundaries to an outside corner's two adjacent outside corner areas—as shown in FIG. 7A-7E—meaning that the whole inventive snap clamp circumference around the length (Z-) direction logically can be regarded as covered by outside corner area.

Of course many other variants can be made from the informations revealed here by the effort of a person skilled in the art. Which of these variants are scoped by the present invention must be judged from the appended claims.

1-7. (canceled)

8. Snap clamp for mounting article of substantially constant outer cross section, preferably flextube for a floor heating system, to a support structure at least comprising rodshaped lengthy elements distributed as two stacked layers, the direction of an outer layer's lengthy element(s) substantially perpendicularly is crossing the direction of the adjacent layer's lengthy element(s), the stacked said elements preferably being interconnected at a crosspoint, such support structure preferably being a reinforcement grid/mat, said snap clamp's design being of overall box-shape with substantially square section normal to it's length direction; said snap clamp at one end's corners has four flexing longitudinal gripping fingers to receive and hold the article in one of two mutually perpendicular lateral directions, between two opposed pairs of neighbouring fingers; said snap clamp at the other end has two mutually perpendicularly crossing substantially U-shaped snap grooves, each extending between opposed sides, the snap effect possibly resulting from slightly U-groove undercut, one snap groove being deeper from this end's plane to fit; receive; and hold, a rodshaped element from the support structure's outer layer, in one of the two possible opposed directions, the other snap groove being of substantially less depth from said end's plane to—at a cross-point—fit; a little later receive; and simultaneously hold, a rodshaped element from the support structure's adjacent layer; said snap clamp preferably being moulded from a plastic material with some flexibility, e.g. a POM-grade; said snap clamp preferably having supplementary longitudinal through holes, slits, cut-outs, and reduced-thickness area(s) to save volume of contained material, and/or to adjust flexing/snapping characteristics, and a possible, adapted supplementary snap clamp mounting tool, wherein a section profile of at least one of the four outside corners from the four intersections of two adjacent side faces of said snap clamp has a form which geometrically is clearly different from the form(s) of other corners, (e.g. combination(s) from sharp/rounded/chamfered/notched/non-symmetric about corner's diagonal) and—if provided—the possible supplementary mounting tool being adapted to said snap clamp by means of a plate, channel, receptor, or the like, comprising a (through-) hole, cut-out, or “mask” with corner profilations of more than one form having mutual relative positions coordinated with the different corner profilations of the actual characterized snap clamp, to hinder longitudinal insertion/reception in the mounting tool, of said snap clamp in an undesired state of position, by physically blocking the entrance/passage of one or more corners of said snap clamp.

9. Snap clamp according to claim 8, wherein two sharp corners are diagonally opposed, the two other corners relatively being clearly non-sharp.

10. Mounting tool according to claim 8, wherein the “mask” having two diagonally opposed sharp corners, the two other corner's profiles being blocking for said clamp's sharp corners, but are permitting passage of any other clamp corner.

11. Snap clamp according to claim 8, wherein the leg corners, having undercut cut-outs matching the form of the fingers of said snap clamp, thus permitting snapping together in the length direction of more similar said snap clamps on top of another to form a coherent rod-like structure.

12. Mounting tool according to claim 8, having a magazine to accept one or more coherent rod-like structure(s) of said snap clamps.

13. Snap clamp according to claim 11, wherein the leg corners, having cut-outs selectively matching the forms of the fingers of a same snap clamp, thus only permitting snapping together in the length direction of more similar said snap clamps on top of another to form a coherent rod-like structure, substantially all along it's length having same inventive differing outside corner profilations, as a said same snap clamp being extruded along its length direction.

14. Combination of snap clamp and mounting tool according to claim 8, wherein said snap clamp's inventive corner configuration, and the tool's inventive “mask” corner configuration being mutually coordinated to specialized arrangements to: —yield the mask's accept for entrance/passage of said snap clamp (or “stick” made from said snap clamps—preferably according to claim 6), if the clamp/stick is situated in an allowable rotated state around it's length direction, and is introduced with that end first, which by leaving the tool “legsfirst”, causes correct delivery of said snap clamp from the tool towards the support structure; and—else yield rejection of entrance/passage of said clamp/stick.
